(19) United States
(12) Patent Application Publication
(10) Pub. No.: US 2009/0031684 A1
(43) Pub. Date: Feb. 5, 2009

(54) Filtration apparatus

(76) Inventor: Charles J. Ragona, Port Barre, LA (US)

Correspondence Address: Ted M. Anthony, P.O.Box 3408, Lafayette, LA, 70502, US

(21) Appl. No.: 12/221,481

(22) Filed: Aug. 4, 2008

Related U.S. Application Data
(60) Provisional application No. 60/963,296, filed on Aug. 3, 2007.

(51) Int. Cl. B01D 50/00

(52) U.S. Cl. 55/383

(57) ABSTRACT

An automatic air filtration apparatus that beneficially controls air circulation in an area to be filtered and removes large amounts of airborne particles and other contaminants from an environment is provided. A hollow frame is formed from screen material having sheet-like filter media disposed across the frame; the filter media is beneficially provided in roll form. The filter media extends off of a supply roll, over the screen frame, and is received on a “take-up” spool. Fans direct opposing streams of air out both lateral ends of the filtration apparatus, thereby creating a suction effect toward the center of the apparatus. Dust particles, contaminants and other debris in an environment are directed back to the filtration apparatus to be collected on the filter material.

### CROSS REFERENCES TO RELATED APPLICATION

This Non-Provisional Patent Application Claims the Benefit of U.S. Provisional Patent Application Ser. No. 60/963,296, filed Aug. 3, 2007.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to an air filtration apparatus. More particularly, the present invention pertains to an air filtration apparatus that can be used in virtually any location to remove airborne particles and other contaminants from an environment.

2. Brief Description of the Prior Art

Health risks and environmental concerns associated with airborne contaminants and poor air quality are well known. Airborne contaminants can cause health problems when inhaled by humans and animals. Further, such airborne contaminants—especially particulate matter—can adversely affect machinery, electrical equipment, ventilation, and heating and cooling systems. Electrical equipment in particular can magnetically attract suspended particles that, in turn, can greatly shorten the life span of such electrical components.

Existing heating, ventilation and air conditioning (“HVAC”) systems, as well as dedicated ventilation systems, typically include filters that serve to remove particles and other contaminants from incoming supply air. However, filters for such systems can become clogged or obstructed easily, especially in highly contaminated environments. Replacement of such filters can be expensive, labor intensive and time consuming. Further, such existing filtration systems frequently fail to adequately move or circulate air throughout an entire area being serviced; as a result, many airborne particles and/or other contaminants are not directed toward the filter and, accordingly, are not removed from the environment.

Existing filtration systems are especially ineffective and troublesome in locations having relatively large amounts of airborne particles, debris and/or other contaminants. Such locations are too numerous to identify. By way of illustration, but not limitation, environments having large amounts of airborne particles, debris and/or other contaminants include woodworking shops, metal fabrication facilities, bakeries and food processing facilities and dental laboratories. Existing air filtration systems have proven to provide less than optimal results in such environments.

The present invention provides a highly effective, inexpensive and low-maintenance apparatus for filtering airborne particles and other contaminants from areas. The apparatus of the present invention provides a cleaner environment for personnel and equipment including, without limitation, in industrial or work environments having large amounts of airborne particles, debris or contaminants.

### SUMMARY OF THE PRESENT INVENTION

The present invention comprises an automatic air filtration apparatus that beneficially controls air circulation in an area to be filtered and removes large amounts of airborne particles and other contaminants from an environment. In the preferred embodiment, the present invention comprises a substantially hollow frame formed from screen material having sheet-like filter media disposed across said screen. Said filter media is beneficially provided in roll form; the rolled filter media is received on a spindle disposed along one side of said frame. The filter media extends off of said roll, over the screen frame, and is received on a “take-up” spool and spindle assembly. In the preferred embodiment, the filter roll spindle and take-up spool assembly are motorized.

At least one variable speed motor is disposed within said substantially hollow frame. In the preferred embodiment, said at least one motor is a single motor having two opposing drive shafts. Said drive shafts are axially aligned with one another, and oriented substantially parallel to the longitudinal axes of said filter roll and take-up spool. Opposing propeller fans are mounted to the shafts of said motor and face toward opposite ends of said frame.

In operation, said propeller fans force a stream of air out both ends of said frame, thereby creating a suction effect toward the center of the apparatus and a pressure drop across the filter media. Said air stream can beneficially control the pattern of air flow in a specific area, essentially creating a control vortex that moves the air flow around a room or other area while collecting dust particles, and then directing air flow back to be collected on filter material.

A sensor measures the pressure drop across the filter media and signals the motorized filter roll spindle and take-up reel to automatically advance the filter media across the frame in accordance with predetermined settings. Specifically, the apparatus of the present invention senses when the filter media is clogged or obstructed and automatically replaces the clogged or obstructed filter media with clean filter media, thereby reducing/eliminating the time and expense associated with changing stationary filters. In the preferred embodiment, said frame is beneficially shaped to maximize surface area of said filter media and reduce spooling drag.

The present invention enhances, rather than interferes with, existing HVAC or ventilation systems in an area. “Dead spots” having little or no air movement within an area are significantly decreased because the present invention creates additional airflow within said area. The present invention controls the airflow pattern to direct and collect the maximum amount of suspended particles from a room or large building.

Flow directing wings or grids can be added to directionally divert filtered air exiting the apparatus and thereby generate a controlled vortex. If desired, the present invention can be equipped with a motorized and remotely controlled lifting mechanism to raise and lower the apparatus. Additionally, a slow-timer spindle can be provided to oscillate the apparatus. Replacement filter media rolls can be easily installed with snap-in installation.

In the preferred embodiment, the present invention filter media take-up spool conveys collected dust particles into a chamber for safe and convenient disposal. Sensor switches maintain substantially constant airflow across the filter media. The filter material can be advanced only enough to maintain a desired airflow rate across the filter. Alternatively, the filter material can be advanced enough to completely replace the filter material covering the screen.

The filter material for the present invention can be in various and assorted sizes and lengths. In one embodiment, the filter media take-up spool includes an individual spring-loaded chamber that moves in and out for easy loading. A split take-up spool spindle permits easy loading and unloading of filter material, as well. Such split design allows for easy loading of new material.

The preferred embodiment of the present invention is beneficially equipped with at least one flashing indicator light that signals when the filtration unit is running low on filter media. Said flashing indicator signals low filter media before such filter media roll is completely exhausted, thereby allowing ample time to install new filter media.

A temperature switch interrupts power to the present invention in the event of a fire. Beneficially, all materials used in the construction of the present invention pass all government and fire marshal codes and regulations.

The apparatus of the present invention can be installed in a number of different ways including, without limitation, the following:

1. Above the entrance door to a room;

2. To the ceiling between two rooms; and

3. As a portable, freestanding unit and moved from room to room, as needed.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a side perspective view of the frame assembly of the filtration apparatus of the present invention.

FIG. 2 depicts a side section view of the filtration apparatus of the present invention.

FIG. 3 depicts an end view of the filtration apparatus of the present invention.

FIG. 4 depicts a perspective view of rolled filter media of the present invention.

FIG. 5 depicts a perspective and partially exploded view of the split take-up spool spindle of the filtration apparatus of the present invention.

### DETAILED DESCRIPTION OF A PREFERRED EMBODIMENT OF THE INVENTION

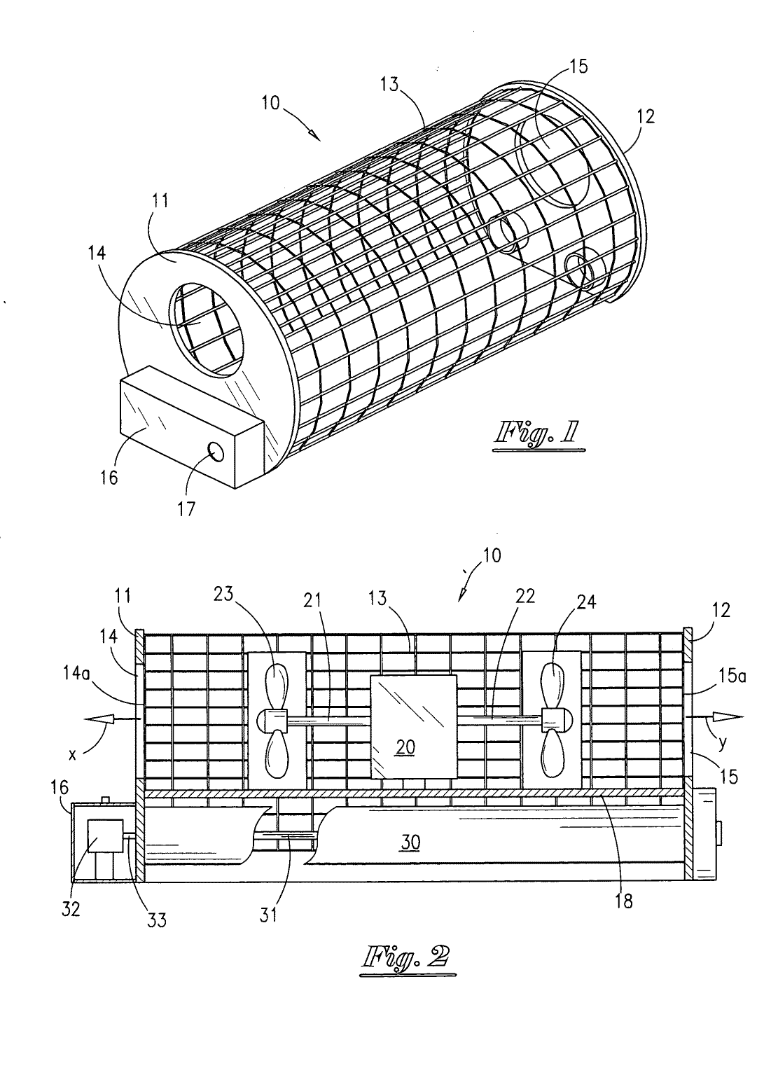

The present invention comprises an automatic air filtration apparatus that beneficially controls air circulation in an area to be filtered, and removes airborne particles, contaminants and/or debris from such area. Referring to the drawings, FIG. 1 depicts a side perspective view of the frame assembly of the filtration apparatus 10 of the present invention. It is to be observed that various elements of functioning filtration apparatus 10 are not depicted in FIG. 1 solely for illustration clarity purposes, but are shown in detail in subsequent figures.

Said frame assembly generally comprises substantially parallel and planar end members 11 and 12, as well as screen material 13 extending between said substantially planar end members 11 and 12. In the preferred embodiment, said screen material 13 forms a substantially rounded body section disposed between said substantially planar end members 11 and 12, and defines an inner void or chamber between said ends. The openings in screen material 13 can be beneficially sized to accommodate the type of filter material to be used, the suction effect of the filtration unit (as described below), as well as the characteristics of the contaminants to be filtered from the surrounding environment. It is to be observed that the frame of the present invention may be formed by connecting means other than a screen; by way of illustration, but not limitation, said frame can be constructed of spaced-apart elongate members extending between substantially planar end members 11 and 12.

Substantially planar end member 11 has outlet port 14, while substantially planar end member 12 has outlet port 15. In the preferred embodiment, outlet ports 14 and 15 are substantially circular in shape and are in linear alignment with one another. Motor housing 16 is disposed on substantially planar end member 11, while access port 17 is provided in said motor housing 16.

FIG. 4 depicts sheet-like filter media 30 in roll form. Filter media 30 has leading end 30a, and can be partially unrolled and disposed over the substantially rounded body section of filtration apparatus 10 formed by screen material 13.

FIG. 2 depicts a side section view of filtration apparatus 10 of the present invention. Substantially planar end members 11 and 12 form the parallel lateral ends of filtration apparatus 10. It is to be observed the screen material 13 extends between planar end members 11 and 12, and forms a substantially hollow body section for filtration apparatus 10 in the manner depicted in FIG. 1. However, although present on the filtration apparatus of the present invention, such screen material 13 is not depicted along the sides of said apparatus in FIG. 2 for illustration clarity in depicting the internal components of said filtration apparatus 10.

Still referring to FIG. 2, substantially planar base 18 extends between and is oriented perpendicular to substantially planar end members 11 and 12. In the preferred embodiment, double-shafted variable speed motor 20 having opposing first drive shaft 21 and second drive shaft 22 is disposed on substantially planar base 18; said drive shafts 21 and 22 are oriented substantially perpendicular to substantially planar end members 11 and 12. First fan propeller 23 is mounted to first drive shaft 21, while second fan propeller 24 is mounted to second drive shaft 22. In the preferred embodiment, first fan propeller 23 and second fan propeller 24 comprise five-bladed propellers oriented to direct air flow outward and away from one another. Put another way, first fan propeller 23 is oriented to direct air flow through outlet port 14 of end member 11 in the general direction of arrows “x”, while second fan propeller 24 is oriented to direct air flow through outlet port 15 of end member 12 in the general direction of arrows “y.” Safety screen 14a extends across outlet port 14, while safety screen 15a extends across outlet port 15.

Filter media roll 30 is disposed on spindle 31. Spindle 31 is disposed between substantially planar end members 11 and 12, and is oriented substantially parallel to drive shafts 21 and 22. Spindle 31 rotates about its longitudinal axis. Drive motor 32 is mounted within motor housing 16, and drive shaft 33 of drive motor 32 is connected to spindle 31. Actuation of drive motor 32 results in rotation of spindle 31.

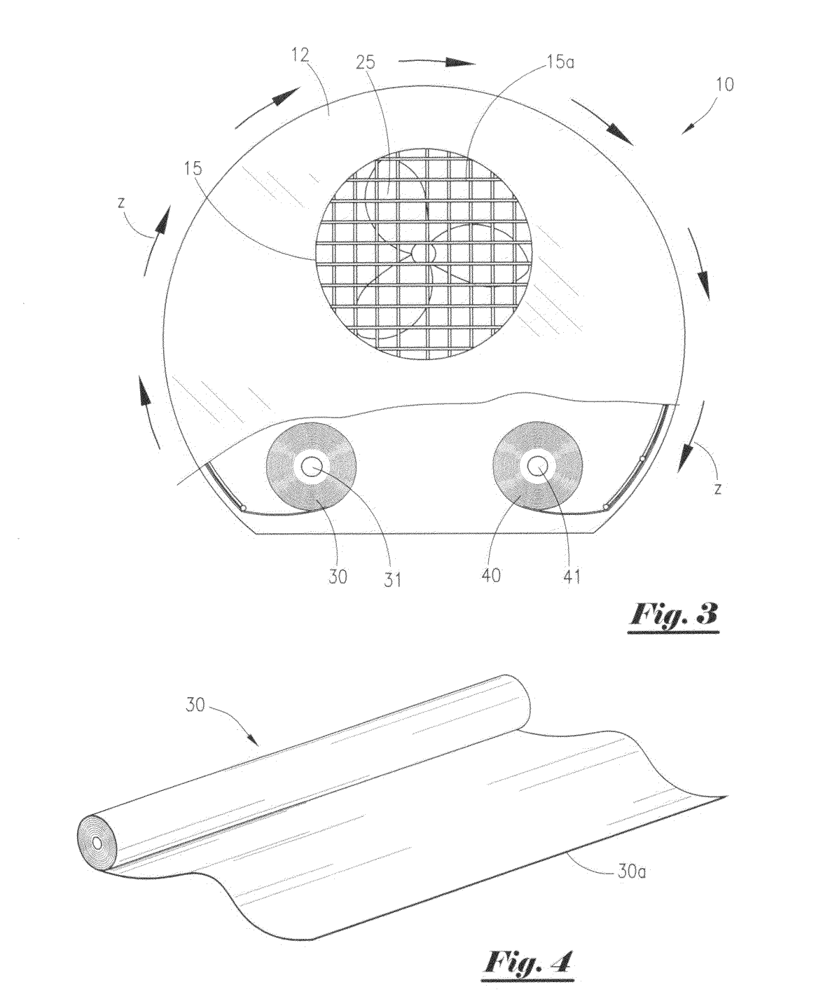

FIG. 3 depicts an end view of the filtration apparatus 10 of the present invention. Substantially planar end member 12 forms a lateral end of said filtration apparatus 10. Substantially circular outlet port 15 extends through said end member 12. Safety screen 15a covers outlet port 15 to prevent unwanted access to fan propeller 24 and other internal elements of filtration apparatus 10 via said outlet port 15.

Still referring to FIG. 3, filter media roll 30 is disposed on spindle 31. Take-up spool 40 of used filter material is disposed on spindle 41. In the preferred embodiment, take-up spool 40 of used filter material and spindle 41 are enclosed within a cylindrical housing, and oriented substantially parallel to filter media roll 30 and spindle 31. Filter media extends off of roll 30, is disposed over the surface of screen 13 (not visible in FIG. 3), and is received on a “take-up” spool 40. Referring to FIG. 3, said filter media generally follows the path depicted by arrows “z”. In the preferred embodiment, rotation of filter roll spindle 31 and take-up spool spindle 41 are beneficially synchronized so that filter media remains substantially taut across the surface of screen 13, without any excess or gathers.

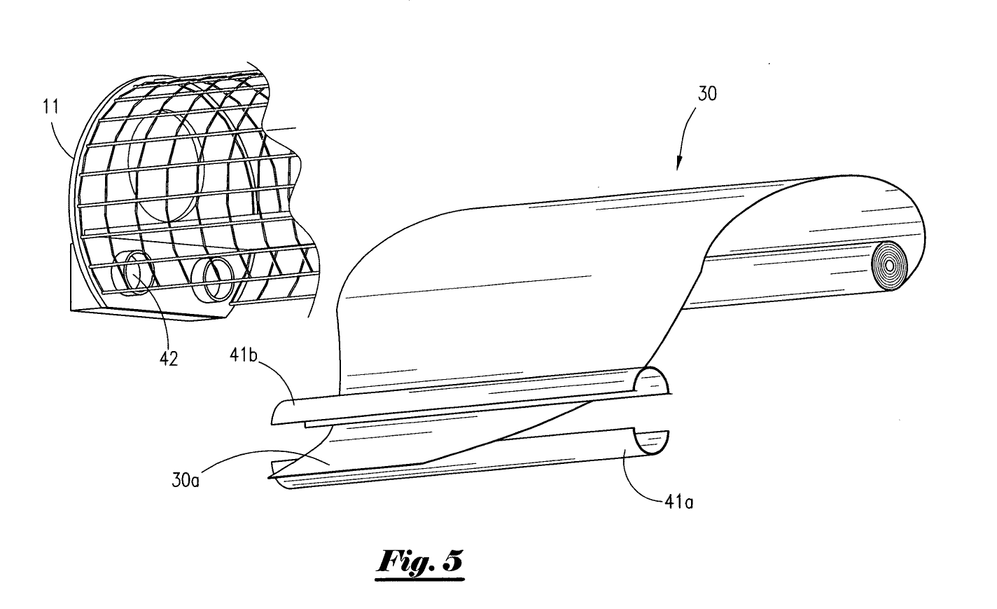

FIG. 5 depicts a perspective, partially exploded view of split take-up spool spindle 41 of the present invention. In the preferred embodiment, said take-up spool spindle 41 comprises opposing semi-cylindrical members 41a and 41b. The leading end 30a of sheet-like filter media 30 can be threaded between said members 41a and 41b. Said members 41a and 41b, with filter media end 30a there-between, can then be inserted into a cylindrical housing for containing collected contaminants. Said members 41a and 41b are connected to spindle receptacle 42 disposed in substantially planar end member 11. Although not depicted in the drawings, in the preferred embodiment, spindle receptacle 42 is connected to a drive motor (similar to drive motor 32) in housing 16. Actuation of such drive motor results in rotation of spindle 41 and take-up spool 40.

When filter material has been fully exhausted, all used filter material (and associated particles and contaminants attached thereto) will be disposed on said take-up spool spindle 41. In the preferred embodiment, such material will be contained within a cylindrical housing, where such material can be accessed for safe and convenient disposal.

In operation, said fan propellers 23 and 24 direct opposing streams of air out both lateral ends of said filtration apparatus 10, thereby creating a suction effect toward the center of said apparatus and a pressure drop across the filter media 30 disposed across said screen 13. Said air streams can beneficially control the pattern of air flow in a specific area to be filtered. In the preferred embodiment, said air steams essentially create a control vortex and move air flow around a treatment area. Such air flow collects dust particles, contaminants and other debris from the environment, and directs air flow back to the filtration apparatus 10 to be collected on said filter material.

The present invention enhances, rather than interferes with, existing ventilation and HVAC systems in an area. “Dead spots” having little or no air movement within an area are eliminated or significantly decreased because the present invention creates airflow within said area. The present invention controls the airflow pattern to direct and collect the maximum amount of suspended particles from a room or large building.

A sensor measures pressure drop across the filter media 30 and signals the motorized filter roll spindle 31 and take-up spool spindle 41 to automatically advance the filter media 30 across screen 13 in accordance with predetermined settings. Specifically, the apparatus of the present invention senses when the filter media is clogged or obstructed and automatically advances said filter media to replace the clogged or obstructed filter media with clean filter media, thereby reducing/eliminating the time and expense associated with changing stationary filters. In the preferred embodiment, a computerized controller mechanism directs drive motor 20 (and fan propellers 23 and 24) to slow or stop while said filter media is being advanced. In this manner, the suction effect caused by the action of said fan propellers 23 and 24 temporarily ceases to reduce the pressure drop across the filter media and thereby permit easier advancing of such media.

Flow dividers can be added downstream of fan propellers 23 and 24 to divert the air flow exiting the filtration apparatus through outlet ports 14 and 15. One embodiment of flow divider 25 is depicted in FIG. 3. In this embodiment, flow divider 25 comprises two substantially planar members in a “cross-hair” configuration. Said flow dividers directionally divert air leaving filtration apparatus 10 through outlet ports 14 and 15, thereby creating a controlled vortex.

If desired, the present invention can be equipped with a motorized and remotely controlled lifting mechanism to raise and lower the apparatus. Additionally, a slow-timer spindle can be provided to oscillate the apparatus. Sensor switches adjust the rotation of drive shafts 21 and 22 (and fan propellers 23 and 24) in order to maintain a substantially constant airflow. The filter material for the present invention comes in assorted sizes and lengths.

The preferred embodiment of the present invention is equipped with at least one flashing indicator light that signals when the filtration unit is running low on filter media. Said flashing indicator signals low filter media before the unit runs out, allowing ample time to install new filter media.

A temperature switch interrupts power to the present invention in the event of a fire. Beneficially, all materials used in the construction of the present invention pass all government and fire marshal codes and regulations.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A filtration apparatus comprising:
a. a frame having a first end defining an opening, a second end defining an opening, and at least one rounded surface between said first and second ends, said frame further defining an inner chamber between said first and second ends;
b. a first fan disposed within said inner chamber of said frame, wherein said fan is directed toward the opening of said first end;
c. a second fan disposed within said frame, wherein said fan is directed toward the opening of said second end; and
d. a filter media disposed over the rounded surface of said frame.

2. The filtration apparatus of claim 1, wherein said frame further comprises:
a. a first substantially planar end member having at least one opening;
b. a second substantially planar end member having at least one opening;
c. at least one frame member extending from said first substantially planar end member to said second substantially planar end member.

3. The filtration apparatus of claim 2, wherein said at least one frame member comprises a screen.

4. The filtration apparatus of claim 3, wherein said filter media comprises a continuous sheet having a first end and a second end.

5. The filtration apparatus of claim 4, wherein said first end of said filter media is disposed on a roll.

6. The filtration apparatus of claim 5, wherein said second end of said filter media is received on a roll.
